(19) United States
(12) Patent Application Publication
(10) Pub. No.: US 2004/0118886 A1
(43) Pub. Date: Jun. 24, 2004

(54) Apparatus and methods for securing a crossbar to a roof rack

(76) Inventors: David Mirshafiee, Irvine, CA (US); Ron G. Holder, Laguna Niguel, CA (US); Matthew A. Davis, Orange, CA (US)

Correspondence Address: BINGHAM, MCCUTCHEN LLP, THREE EMBARCADERO, SUITE 1800, SAN FRANCISCO, CA, 94111-4067, US

(21) Appl. No.: 10/326,910

(22) Filed: Dec. 19, 2002

(51) Int. Cl. B60R 9/00

(52) U.S. Cl. 224/315; 224/321

(57) ABSTRACT

An apparatus for securing a crossbar to a rail of a rack system for a vehicle includes a housing having a first end including a first jaw and a second end including a track. A crossbar plate is slidable along the track such that a distance between the crossbar plate and the first jaw varies as the crossbar plate slides along the track. A hook is pivotally coupled to the housing and includes a second jaw disposed opposite the first jaw, thereby defining an aperture for receiving a rail therebetween. A lever is pivotally coupled to the housing, the lever securing the crossbar plate relative to the track in a closed position and releasing the crossbar plate to move freely along the track in an open position. In the closed position, the lever moves the second jaw towards the first jaw to secure the rail therebetween.

### FIELD OF THE INVENTION

The present invention relates generally to rack systems for carrying accessories on vehicles, and more particularly to apparatus and methods for securing an adjustable length crossbar to rails of a rack system for a vehicle.

### BACKGROUND

Roof racks and other carrier systems are often provided on an exterior surface of a vehicle for transporting articles, such as luggage, camping equipment, or sporting goods, such as bicycles, skis, and the like. Generally, such systems include a pair of side rails that are attached to the roof, trunk, deck lid, or other outer body surface of a vehicle. Crossbars are attached between the side rails that may be adjusted to various locations along the lengths of side rails.

The cross bars may be secured between the side rails, for example, using clamps on the crossbar that may be tightened to frictionally engage the side rails within the clamps. These clamps may require manual tightening, for example, by turning a screw or bolt. Because a user may not know the appropriate degree to tighten such screws or bolts, the user may not adequately tighten them and consequently the crossbar may inadvertently come loose during use. If this occurs, the crossbar may move, possibly affecting a load being carried by it, or the clamps or cross bar may vibrate or otherwise generate noise.

Another problem with crossbars is that the side rails may not be mounted to the body surface of a vehicle in a parallel configuration, i.e., such that one end of each side rail may be closer together than the other. If multiple crossbars are provided, e.g., one towards each end of the side rails, the crossbars may need different lengths, requiring custom manufacturing of crossbars to fit the side rail spacing encountered in a specific configuration. The resulting fixed length crossbars may also have limited motion along the side rails. For example, the crossbars may not be able to slide freely along the side rails as the spacing between the side rails decreases or the crossbars may not extend completely between the side rails as the spacing increases.

Accordingly, apparatus and methods for securing crossbars to rails of rack systems would be useful.

### SUMMARY OF THE INVENTION

The present invention is directed to rack systems for carrying accessories on automobiles, and more particularly to apparatus for providing an adjustable length and/or self-centering crossbar that may be secured to rails of a rack system.

In accordance with one aspect of the present invention, an apparatus is provided for securing a crossbar to a rail of a rack system for a vehicle. The apparatus may include a housing or end shell including a first end including a first jaw and a second end including a track. A crossbar plate that may be fixed to a crossbar is slidable along the track such that a distance between the crossbar plate and the first jaw varies as the crossbar plate slides along the track. A hook may be coupled to the housing, the hook including a second jaw disposed opposite the first jaw such that an aperture is defined between the first and second jaws for receiving a portion of a rail therebetween, the hook being movable relative to the housing, thereby moving the second jaw relative to the first jaw to adjust a size of the aperture.

A lever may be coupled to the housing and movable between open and closed positions, the lever securing the crossbar plate at a location along the track in the closed position and releasing the crossbar plate to move freely along the track in the open position. In addition or alternatively, the lever may be coupled to the hook such that, in the closed position, the second jaw moves towards the first jaw to minimize the size of the aperture, and, in the open position, the lever releases the hook such that the second jaw is free to move relative to the first jaw.

In a preferred embodiment, a locking element may be carried by the housing, the locking element including a first end coupled to the lever and a region engaging the crossbar plate when the lever is in the closed position to secure the crossbar plate at a location along the track. The region of the locking element engaging the crossbar plate and the crossbar plate may include one or more cooperating teeth that engage one another when the lever is in the closed position to prevent movement of the crossbar plate relative to the locking element.

In one embodiment, the locking element may include an elongate shaft attached to the housing, the shaft being rotatable about its longitudinal axis as the lever is moved between the open and closed positions to disengage and engage, respectively, the one or more cooperating teeth. The lever may include a slot and the shaft may include a tab on the first end receivable in the slot such that movement of the lever causes the tab to move along the slot to rotate the shaft about the longitudinal axis, the one or more cooperating teeth disengaging or engaging as the shaft rotates.

Alternatively, the locking element may include an elongate rod or member at least partially received in a channel in the crossbar plate. The channel may include the one or more teeth on the crossbar plate. When the lever is moved to the closed position, the lever may move the rod transversely relative to the track, thereby engaging the one or more teeth on the rod and the one or more teeth in the channel.

In addition, the apparatus may include a crossbar including a first end attached to the crossbar plate such that a distance between the first end of the crossbar and the first jaw varies as the crossbar plate slides along the track. The second end of the housing may be at least partially inserted into the first end of the crossbar, the second end of the housing being slidable at least partially in and out of the first end of the crossbar as the crossbar plate slides along the track. Optionally, the crossbar may include a second end to which a similar apparatus or other rail grabber may be attached for securing the second end of the crossbar to a rail.

In accordance with another aspect of the present invention, a rack system for a vehicle is provided that includes first and second rails securable to a surface of a vehicle, and a crossbar including first and second ends and having a length less than a distance between the first and second rails.

A first end shell or housing may be secured to the first end of the crossbar, the first end shell including a pair of opposing jaws for receiving the first rail therebetween, and a first lever movable between open and closed positions. The first end shell may be movable relative to the crossbar when the first lever is in the open position and fixed relative to the crossbar when the first lever is in the closed position. A second end shell may be secured to the second end of the crossbar, the second end shell being securable to the second rail. Preferably, at least one of the opposing jaws is coupled to the first lever for securing the first rail between the opposing jaws when the first lever is in the closed position.

In a preferred embodiment, the first end shell includes a housing including a first end including a first jaw and a second end slidably coupled to the crossbar, the first lever being pivotally coupled to the housing. A hook may be coupled to the housing, the hook including a second jaw disposed opposite the first jaw such that an aperture is defined between the first and second jaws for receiving the first rail therebetween, the hook being movable relative to the housing, thereby moving the second jaw relative to the first jaw to adjust a size of the aperture.

The second end of the housing may include a track, and a crossbar plate may be slidable along the track such that a distance between the crossbar plate and the first jaw varies as the crossbar plate slides along the track, the crossbar being attached to the crossbar plate.

In accordance with yet another aspect of the present invention, a method is provided for adjusting a rack system including first and second spaced-apart rails fixed to a surface of a vehicle. A crossbar may be provided that extends between the first and second rails. The crossbar may include a first end including a first end shell including a pair of opposing jaws for receiving the first rail therebetween and a second end including a second end shell securable to the second rail.

A locking lever on the first end shell may be opened to release the opposing jaws from the first rail and allow movement of the first end shell relative to the crossbar. Optionally, the second end shell may also include a pair of opposing jaws for receiving the second rail therebetween. A locking lever on the second end shell may be opened to release the opposing jaws from the second rail and allow movement of the second end shell relative to the crossbar.

Once one or both locking levers are opened to release the respective opposing jaws, the crossbar may be moved along a length of the first and second rails, the end shells moving freely to adjust the overall length of the crossbar to accommodate any change in spacing between the first and second rails. When a desired location is reached, the locking lever on the first end shell may be closed to secure the first end shell relative to the crossbar and/or to secure the first rail between the opposing jaws to fix the crossbar relative to the first rail. If the second end shell includes a locking lever, the locking lever on the second end shell may also be closed to secure the second end shell relative to the crossbar and/or to secure the second rail between the opposing jaws to fix the crossbar relative to the second rail.

In accordance with another aspect of the present invention, a carrier system for a vehicle is provided that includes one or more crossbars that may be attached directly to a surface of a vehicle, e.g., between opposite side edges or rain gutters of a vehicle's roof (often called a “surface mount system”). Each crossbar may include first and second ends, a first end shell or hook assembly secured to the first end of the crossbar, and, optionally, a second end shell or hook assembly secured to the second end of the crossbar.

At least the first end shell includes a lever movable between open and closed positions, and an adjustable hook. When the lever is in the open position, the end shell may be movable relative to the crossbar, while being biased towards or away from the crossbar. When the lever is in the closed position, the end shell may be fixed relative to the crossbar, thereby fixing the overall length of the crossbar. Optionally, the second end shell may also include a lever, and an adjustable hook, although alternatively, the second end shell may include a stationary hook with or without a lever.

In a preferred embodiment, the first end shell includes a housing including a first end to which a hook is pivotally coupled, a second end slidably coupled to the crossbar, and a lever pivotally coupled to the housing. The hook may include a jaw oriented transversely relative to a longitudinal axis of the crossbar, and may be pivotable or otherwise movable relative to the housing. The hook may also be coupled to the lever such that, as the lever is directed to the closed position, the jaw of the hook may be pivoted or otherwise directed towards or away from the crossbar. The second end of the housing may include a track, and a crossbar plate, secured to the first end of the crossbar, may be slidable along the track such that a distance between the crossbar plate and the housing varies as the crossbar plate slides along the track.

Preferably, each of the first and second ends of the crossbar includes an end shell or hook assembly including a hook and lever such that, as the lever on each end of the crossbar is moved towards the closed position, the hooks are directed towards one another. Thus, for example, with the levers in the open positions, the hooks may be received around opposite edges of a vehicle surface, e.g., the opposite rain gutters on a vehicle's roof. Preferably, the hooks are biased to move towards one another, e.g., by a spring or other mechanism within the respective end shell. Thus, with the levers in the open position, the hooks may be directed apart to receive them around opposite edges of a vehicle surface, but the hooks may automatically return towards one another to minimize the space between the hooks and/or to center the crossbar over the vehicle surface. The levers may be directed to the closed positions, thereby directing the hooks towards one another and grasping the vehicle surface between the hooks. Thus, the hooks may substantially secure the crossbar to the vehicle, while substantially simultaneously fixing the overall length of the crossbar.

Other objects and features of the present invention will become apparent from consideration of the following description taken in conjunction with the accompanying drawings.

### BRIEF DESCRIPTION OF THE DRAWINGS

FIG. 1 is an exploded perspective view of a first preferred embodiment of an apparatus for securing a crossbar to a rail, in accordance with the present invention.

FIGS. 2A and 2B are perspective views of the apparatus of FIG. 1 with a locking lever in closed and open positions, respectively.

FIG. 3A is a cross-sectional view of the apparatus of FIG. 2A taken along line 3A-3A.

FIG. 3B is a cross-sectional view of the apparatus of FIG. 2B taken along line 3B-3B.

FIG. 3C is a cross-sectional view of the apparatus of FIG. 2A taken along line 3C-3C.

FIG. 3D is a partial top view of the apparatus of FIG. 2A, showing a locking shaft for coupling movement of a crossbar plate to a lever.

FIG. 3E is a detail of the locking shaft and crossbar plate of FIG. 3D, showing teeth on the locking shaft and crossbar plate interlocking to secure the crossbar plate from movement.

FIGS. 4A and 4B are top and bottom perspective views, respectively, of an end shell for the apparatus of FIG. 1.

FIG. 4C is a cross-sectional view of the end shell of FIGS. 4A and 4B, taken along line 4C-4C.

FIG. 5 is a perspective view of a hook for the apparatus of FIG. 1.

FIGS. 6A and 6B are perspective views of an adjustable crossbar plate for the apparatus of FIG. 1.

FIG. 7A is a perspective view of a locking lever of the apparatus of FIG. 1.

FIGS. 7B-7D are top and side views of the locking lever of FIG. 7A.

FIG. 8A is a perspective views of a locking rod for the apparatus of FIG. 1.

FIGS. 8B and 8C are top and side views, respectively of the locking rod of FIG. 8A.

FIG. 9 is a partial cross-sectional detail of the apparatus of FIGS. 1 and 2B.

FIG. 10 is an exploded perspective view of a second preferred embodiment of an apparatus for securing a crossbar to a rail, in accordance with the present invention.

FIGS. 11A and 11B are top and bottom views of the assembled apparatus of FIG. 10.

FIG. 12 is a perspective view of a rack system for a vehicle, including adjustable crossbars, in accordance with the present invention.

### DETAILED DESCRIPTION OF THE PREFERRED EMBODIMENTS

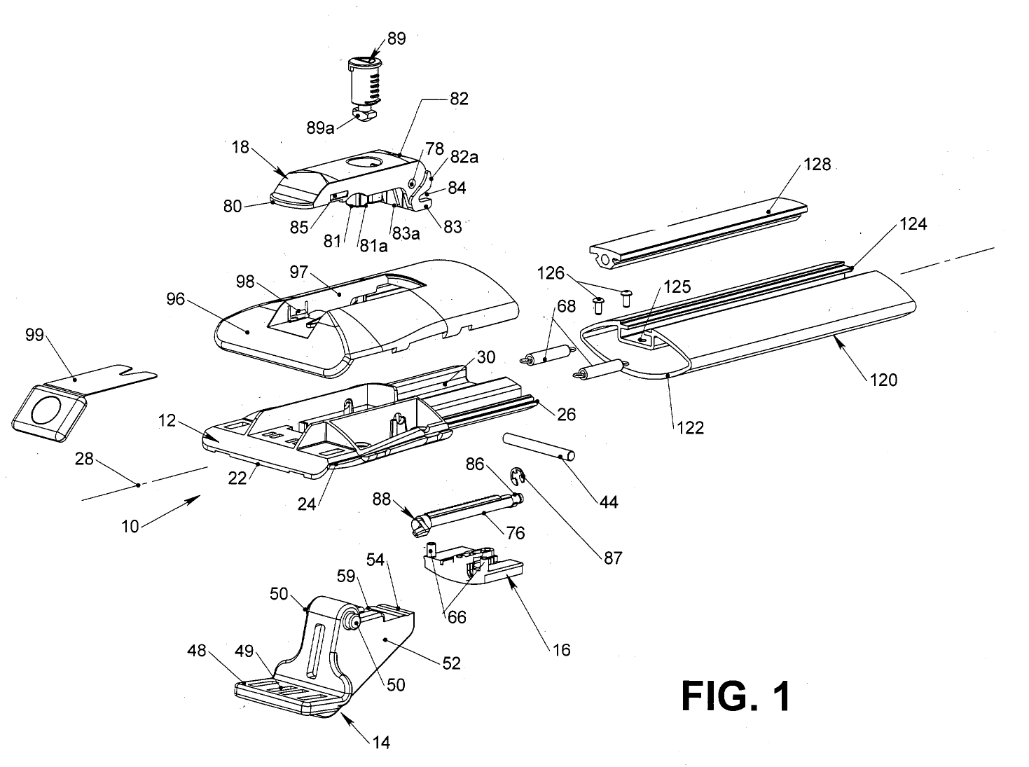

Turning to the drawings, FIGS. 1-9 show a first preferred embodiment of an apparatus 10 for securing a crossbar 120 to a rail (not shown) including an end shell or housing 12, a hook 14 coupled to the end shell 12, a crossbar plate 16 slidable relative to the end shell 12, and a lever 18 for releasing and/or securing the hook 14 and/or the crossbar plate 16 relative to the end shell 12. In a preferred embodiment, the apparatus 10 includes an elongate rod, tube, or shaft 76 or other locking element (not shown) for coupling the lever 18 to the crossbar plate 16, e.g., to release and/or secure the crossbar plate 16 relative to the end shell 12. The apparatus 10 may also include an end shell cover 96 attachable to the end shell 12, e.g., to provide a contoured profile and/or a desired aesthetic appearance for the apparatus 10.

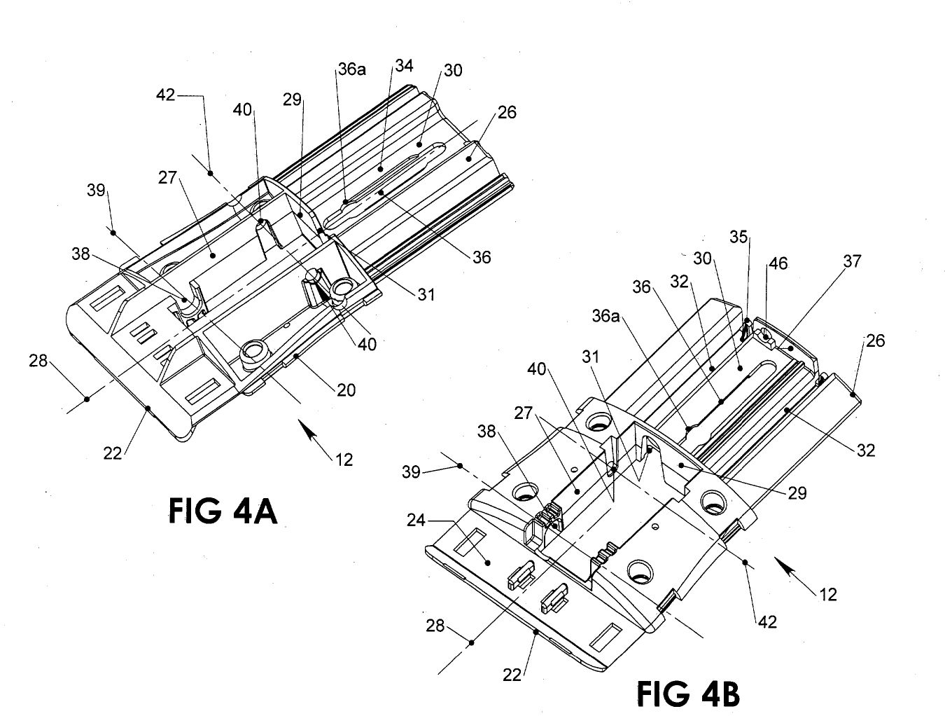

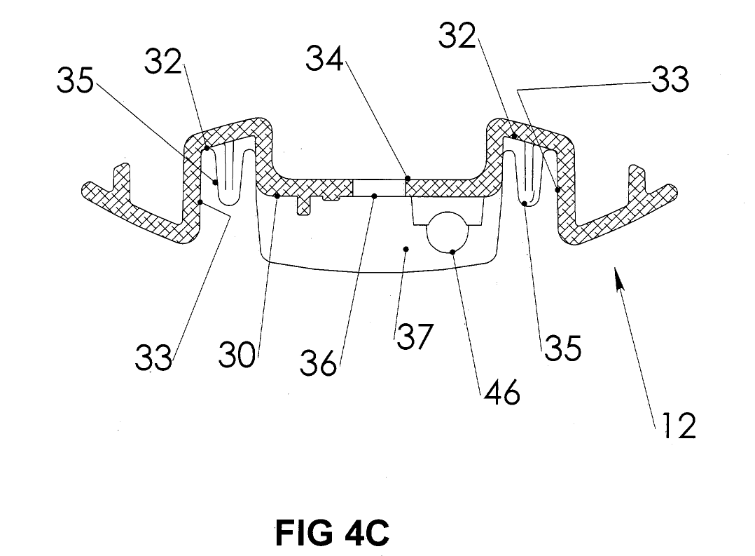

With particular reference to FIGS. 4A-4C, the end shell 12 is an elongate body 20, preferably having a substantially flat and/or elliptical cross-section, that includes a first end 22 and a second end 26, thereby defining a longitudinal axis 28 therebetween. The first end 22 includes an upper or first jaw 24, and the second end 26 includes a track 30 for slidably receiving the crossbar plate 16 (not shown, see FIG. 1) there along. An opening 25 may extend through the end shell 12 transversely to the longitudinal axis 28, thereby defining inner side surfaces 27 and an intermediate wall 29 between the opening 25 and the track 30.

With particular reference to FIG. 4C, the track 30 may include a pair of channels 32 that extend substantially parallel to the longitudinal axis 28 on either side of a bottom wall 34. The track 30 also includes a pair of side walls 33 that at least partially define the channels 32. The side walls 33 are preferably spaced apart from one another a sufficient distance such that the crossbar plate 16 may be slidably received between the side walls 33, as explained further below.

The bottom wall 34 includes an elongate slot 36 therethrough that extends substantially parallel to the longitudinal axis 28. Preferably, the slot 36 has a length that limits the range of sliding motion of the crossbar plate 16 along the track 30, as explained further below. The slot 36 may include an enlarged region 36a, e.g., having a generally circular shape for facilitating coupling the crossbar plate 16 to the track 30, also as explained further below.

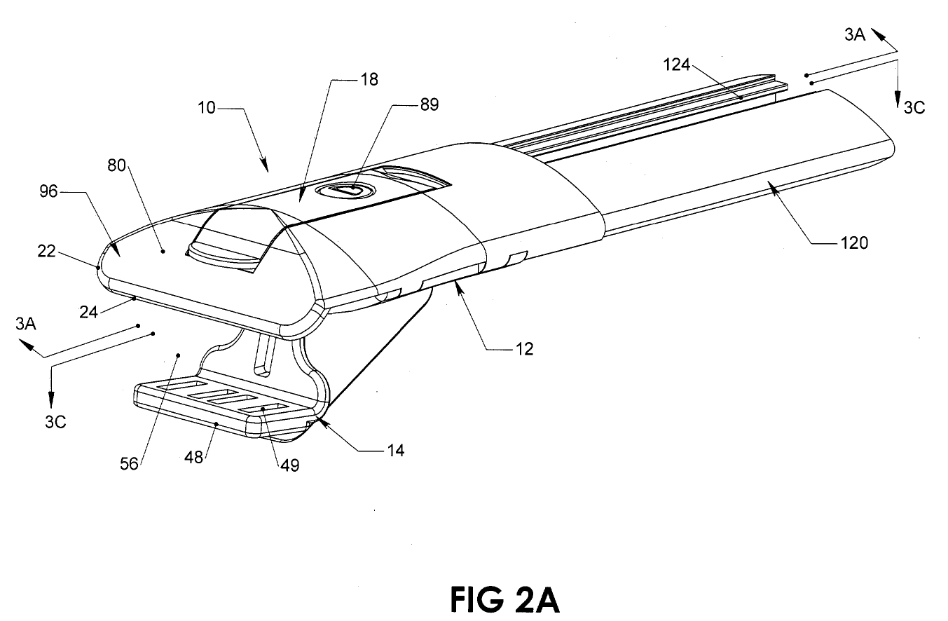

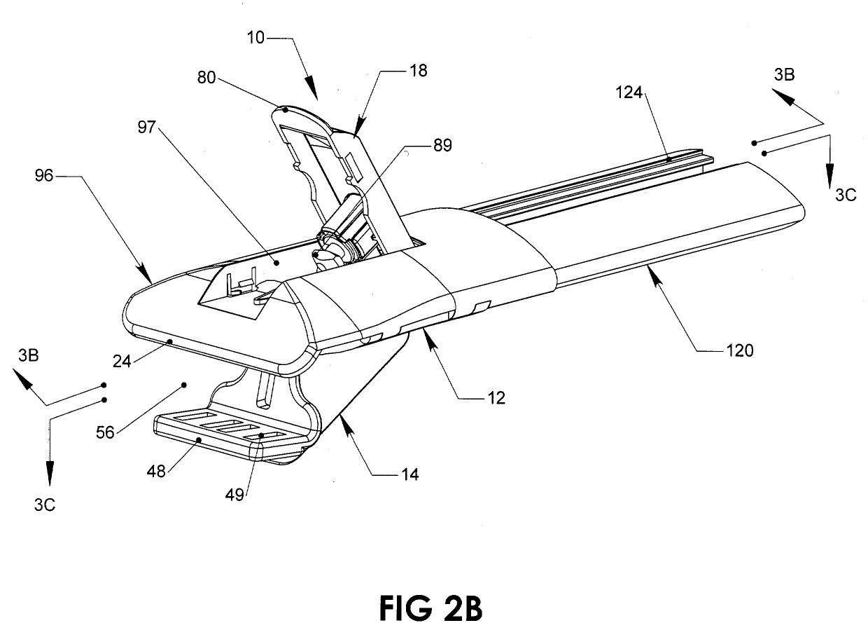

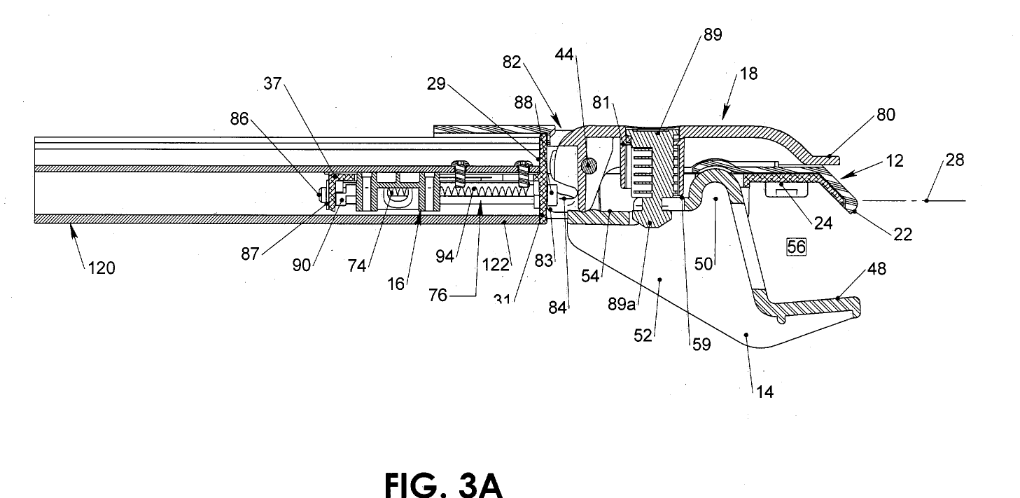

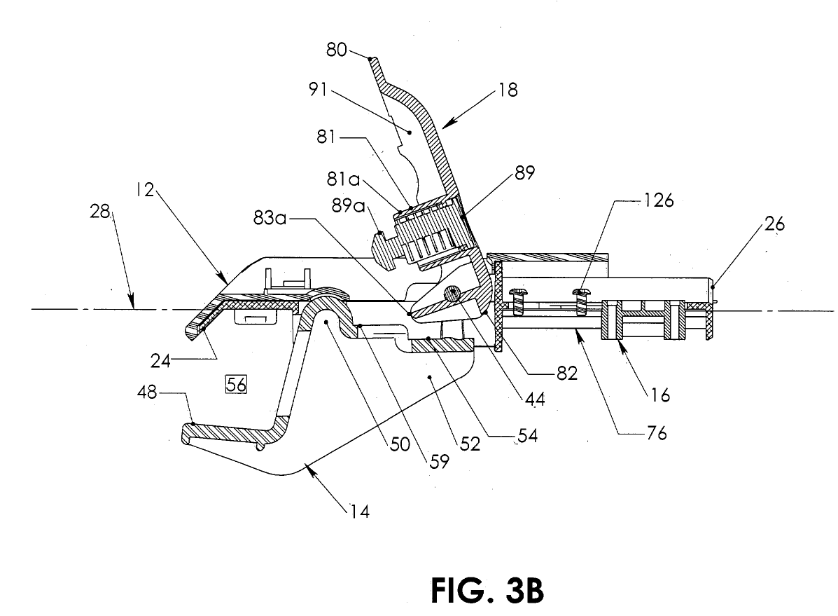

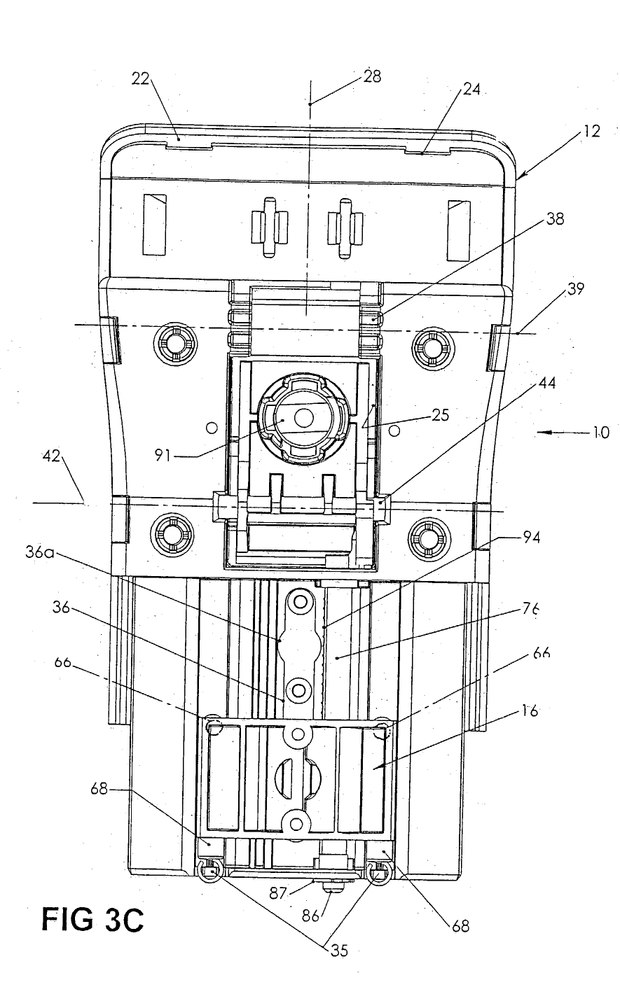

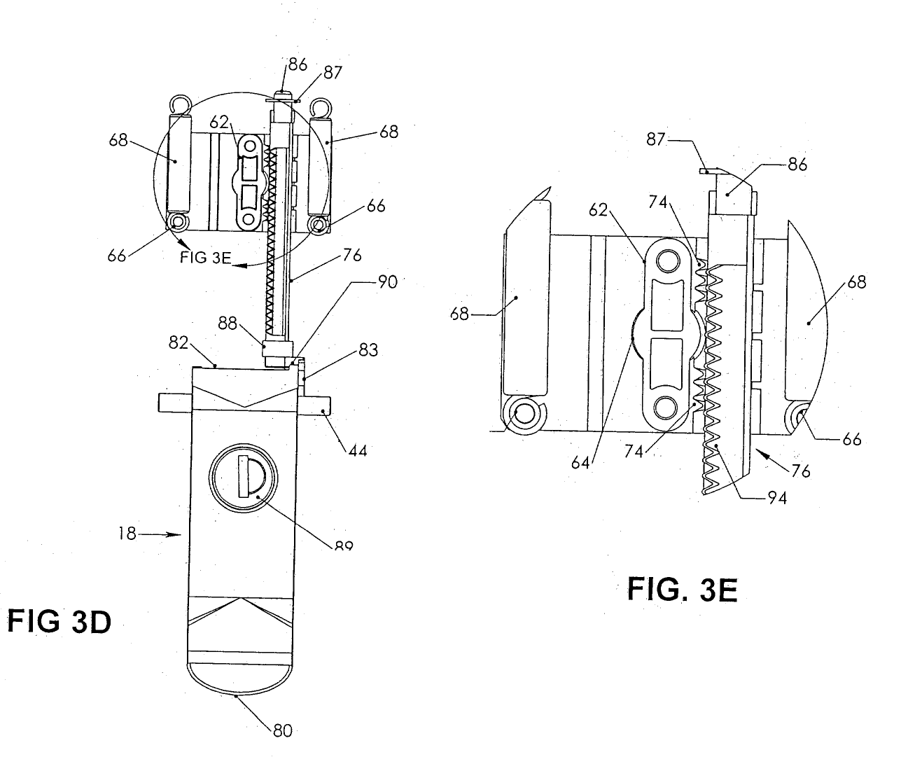

The second end 26 of the end shell 12 may be shaped such that the second end 26 may be inserted into a similarly shaped end 122 of a crossbar 120 (not shown, see FIGS. 2A-3C). For example, the second end 26 may have a generally elliptical cross-section corresponding to the cross-section of the crossbar 120. Preferably, the tolerances allow the second end 26 to fit sufficiently snugly within the end 122 of the crossbar 120, i.e., providing a male-female connection that prevents substantial lateral movement of the end shell 12 relative to the crossbar 120.

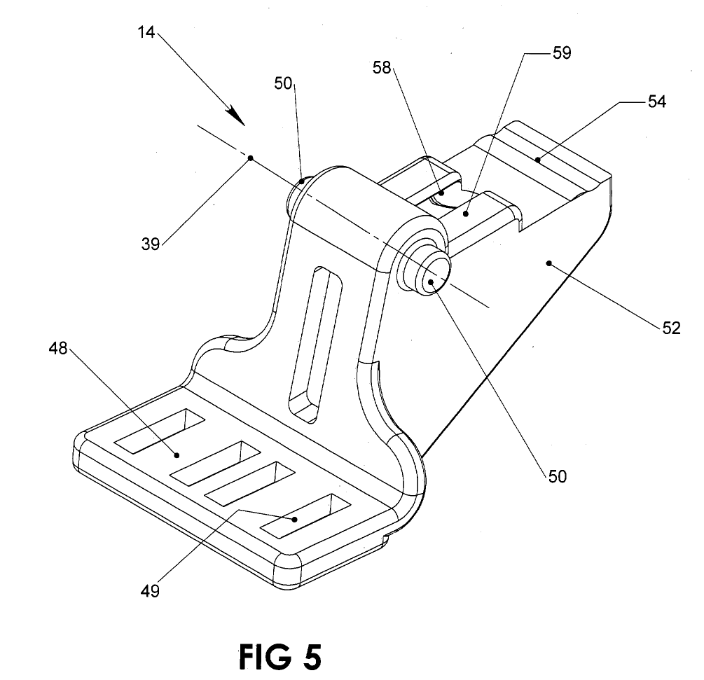

In addition, as best seen in FIGS. 3C, 4A, and 4B, the end shell 12 may include mounts for securing various components of the apparatus 10 to the end shell 12. For example, “C” shaped sockets 38 may be provided within the opening 25 on side surfaces 27. The sockets 38 may receive hubs 50 (not shown, see FIG. 5) on the hook 14 such that the hook 14 may be coupled to the end shell 12, but may be pivoted about axis 39, as explained below.

Apertures 40 may extend through the end shell 12 along an axis 42 transverse to the longitudinal axis 28 for receiving a pin 44 (not shown in FIGS. 4A and 4B, see FIG. 1) such that the lever 18 may be coupled to the end shell 12, but may pivot about the axis 42.

The second end 26 of the end shell 12 may include an end wall 37 that may support the locking shaft 76 and/or may provide an additional stop that may limit the range of sliding motion of the crossbar plate 16 along the track 30. For example, the end wall 37 may include a socket 46 and the intermediate wall 29 may include a hole 31 aligned with the socket 46 for receiving a portion of the locking shaft 76 therethrough, as explained further below. In addition, as shown in FIG. 4C, the track 30 may include one or more hubs 35 for coupling a spring to the track 30. Preferably, a hub 35 is provided in each of the channels 32, e.g., at the end adjacent the end wall 37, for receiving an end of a respective spring 68 (not shown, see FIGS. 1 and 3C), as explained further below.

In a preferred embodiment, the end shell 12 is formed from a single part, e.g., an extrusion, casting, machined part, or molded part, or may be formed from multiple parts that are assembled together, e.g., using an adhesive or other bonding, welding, interference fit, interlocking connector, and the like. The end shell 12 may be formed from a variety of materials, including metal, such as aluminum or steel, or a plastic and/or composite material, such as fiber reinforced plastic (FRP). Similarly, the other components of the apparatus 10, e.g., the hook 14, crossbar plate 16, lever 18, locking shaft 76, and/or end shell cover 96 (see FIG. 1) may also be formed from metal, ceramic, composite, and/or plastic, and may be extruded, machined, cast, molded, roll formed, or made using other known processes.

Turning to FIG. 5, a preferred embodiment of the hook 14 is shown that includes a lower or second jaw 48 and a heel 52 disposed on opposite ends of the hook 14, i.e., on opposite sides of the hubs 50. The heel 52 may include a bearing surface or other element that may cooperate with the lever 18 to pivot the hook 14 relative to the end shell 12. Preferably, the heel 52 includes a raised ledge 59, which may engage the lever 18 (not shown, see FIG. 3A), as explained further below. In addition, a slot 58 may be provided within the ledge 59 adjacent the hubs 50 that may be used to lock the hook 14 relative to the end shell 12, also as explained further below.

Generally, the lower jaw 48 cooperates with the upper jaw 24 on the end shell 12 to define an aperture 56 (not shown, see FIGS. 3A and 3B) for receiving a rail (also not shown) between the opposing jaws 24, 48. The jaws 24, 48 may include features to enhance frictional or mechanical engagement with the rail received therebetween. A pad of rubber or other nonslip material (not shown) may be attached to one or both jaws 24, 48, e.g., using an adhesive, mechanical connectors, and the like, to enhance securing the rail between the jaws 24, 48 and thereby securing the apparatus 10 relative to the rail. For example, in the embodiment shown in FIG. 1, the lower jaw 48 includes apertures 49 through which tabs on a pad (not shown) may be received to secure the pad to the lower jaw 48. The tabs may have enlarged heads (not shown) that may be forced through the aperture 49. The heads may resiliently expand once through the apertures 49 to prevent the tabs from being pulled back through the apertures 49, thereby substantially securing the pad to the lower jaw 48. Alternatively or in addition, one or both jaws 24, 48 may include one or more teeth, tabs, or other connectors (not shown) that may mechanically fit with complementary elements on the rail to secure the apparatus 10 at one or more locations along the rail.

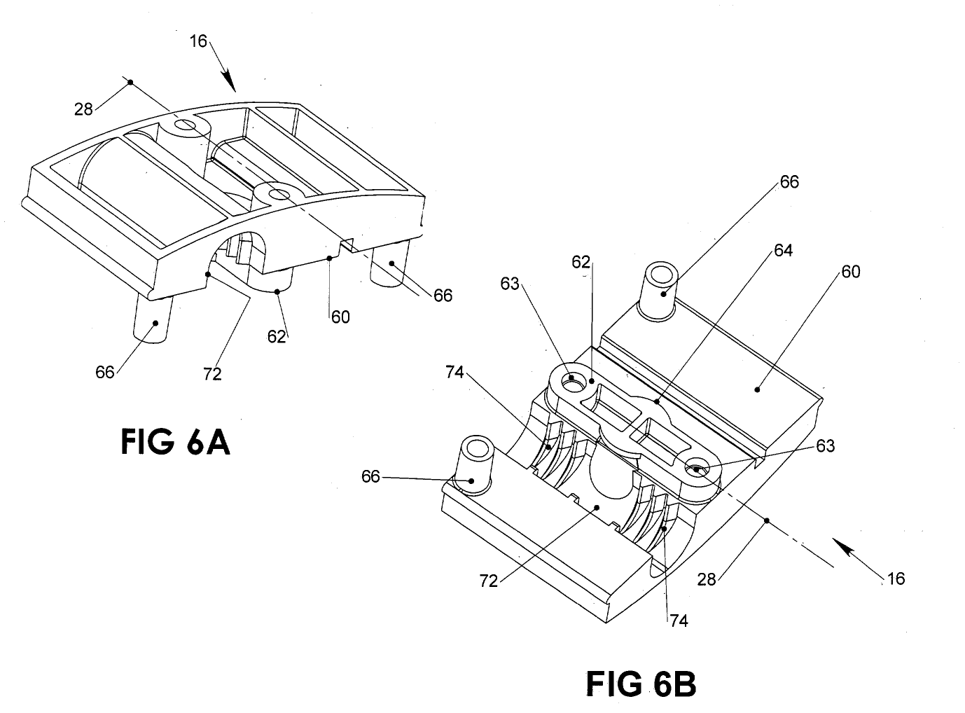

Turning to FIGS. 6A and 6B, an exemplary embodiment of the crossbar plate 16 is shown that may be slidably received along the track 30 of the end shell 12. Generally, the crossbar plate 16 is a substantially flat body, having a width smaller than a distance between the side walls 33 of the track 30 (not shown, see FIGS. 4B and 4C) and a length that is substantially shorter than a length of the track 30.

As best seen in FIG. 6B, the crossbar plate 16 preferably includes a substantially flat upper surface 60 including one or more features, such as an elongate tab 62. The tab 62 preferably has a width narrower than the slot 36 in the track 30 such that the tab 62 may be slidably received in the slot 36, as shown in FIG. 3C, e.g., to stabilize and/or limit movement of the crossbar plate 16 along the track 30. A difference between the length of the slot 36 and the length of the tab 62 may define the range of motion of the crossbar plate 16 relative to the end shell 12, thereby defining the amount of length adjustment of the crossbar (not shown) to which the crossbar plate 16 may be attached. In a preferred embodiment, the track 30 may limit the sliding motion of the crossbar plate 16 along the track 30 (and, consequently, relative to the end shell 12) within a range of approximately zero to two inches (zero to fifty millimeters), and more preferably, approximately two inches (approximately fifty millimeters) or less.

Optionally, the tab 62 may include one or more retaining ledges spaced away from the upper surface 60, and preferably a pair of retaining ledges 64 that extend away from one another generally parallel to the upper surface 60. Preferably, the pair of retaining ledges 64 define a substantially circular shape or are otherwise keyed to fit into a complementary aperture in the slot 36. For example, as shown in FIGS. 4A and 4B, the enlarged region 36a in the slot 36 may have a circular shape through which the ledges 64 may be received, but otherwise the slot 36 may be narrower than the width of the ledges 64. The tab 62 may also include one or more holes 63 therein each for receiving a fastener, such as a screw 126 (not shown, see FIG. 1), for securing the crossbar plate 16 to a crossbar 120 or other structure (also not shown, see FIG. 1).

During assembly, the ledges 64 may be aligned and inserted through the enlarged region 36a of the slot 36 until the tab 62 is seated in the slot 36, as shown in FIG. 3C. When the crossbar plate 16 is slid along the track 30, the ledges 64 may prevent the tab 62 from being removed from the slot 36, and consequently, prevent the crossbar plate 16 from being removed from the track 30 (unless the ledges 64 are realigned with the enlarged region 36a of the slot 36). Once the tab 62 is properly received in the slot 36, the upper surface 60 of the crossbar plate 16 may slide along or in close proximity to the bottom wall 34 of the track 30.

In addition, one or more hubs 66 may extend from the upper surface 60 of the crossbar plate 16 to provide mounts for springs 68 or other elements that may bias the crossbar plate 16 relative to the track 30. For example, as best seen in FIGS. 3C and 6B, a pair of hubs 66 may extend from the crossbar plate 16 to which extension springs 68 may be coupled. As shown in FIG. 3C, the springs 68 may also be coupled to the hubs 35 on the end shell 12 to bias the crossbar 16 towards a position along the track 30, e.g., towards the end of the slot 36 that is closest to the first end 22 of the end shell 12. Alternatively, other spring configurations may be provided for biasing the crossbar plate 16 towards one end of the track 30 or other position along the track 30, as will be appreciated by those skilled in the art.

When the tab 62 is properly received in the slot 36, the hubs 35 and springs 68 may be received in the channels 32 of the track 30. Thus, as the crossbar plate 16 is slid along the track 30, the hubs 66 may slide within the channels 32, compressing or extending the springs 68. Preferably, as the crossbar plate 16 is slid along the track 30 towards the first end 22 of the end shell 12, the spring 68 may be extended, thereby biasing the crossbar plate 16 to return back towards the second end 26 of the end shell 12 once released. Alternatively, the crossbar plate 16 may be biased towards the other end of the track 30, e.g., by moving the hubs 35, 66 to different locations on the crossbar plate 16 and track 30 and/or by using different springs, e.g., one or more compression springs rather than extension springs.

With particular reference to FIG. 6B, the crossbar plate 16 may also include a channel 72 in the upper surface 60 extending substantially parallel to the longitudinal axis 28 for at least partially receiving the locking shaft 76 (not shown, see FIG. 1) therein. For example, the channel 72 may have a partially cylindrical cross-section, e.g., a substantially semi-cylindrical cross-section, similar to the cross-section of the locking shaft 76 such that the locking shaft 76 may not move substantially laterally yet may rotate freely about its axis. The channel 72 may include one or more locking elements that interlock with mating locking elements on the locking shaft 76. For example, the channel 72 may include a plurality of ribs, fins, or teeth 74 that extend along a portion of the channel 72 in a direction transverse to the longitudinal axis 28. Preferably, the teeth 74 extend partially along the circumferential direction of the channel 72 and include tapered ends to facilitate engagement and disengagement with mating teeth or other elements on the locking shaft 76, as explained further below.

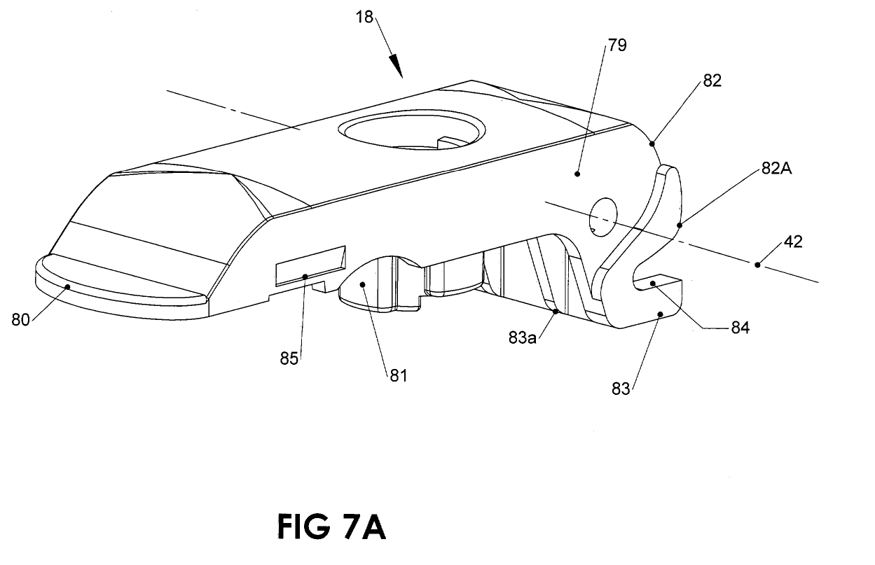

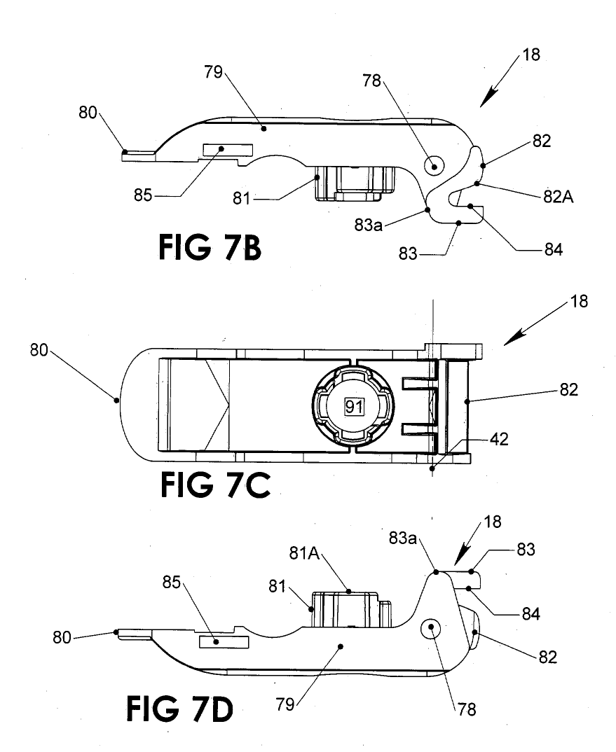

Turning to FIGS. 7A-7D, an exemplary embodiment of the locking lever 18 is shown that may be coupled to the end shell 12, the hook 14, and/or the crossbar plate 16 (not shown in FIGS. 7A-7D). The lever 18 may be pivotally coupled to the end shell 12 and movable between closed and open positions, as shown in FIGS. 3A and 3B, respectively. Preferably, the lever 18 is coupled to the crossbar plate 16 for securing the crossbar plate 16 relative to the track 30 in the closed position and/or for releasing the crossbar plate 16 to move freely along the track 30 in the open position.

In addition or alternatively, the lever 18 may be coupled to the hook 14 such that, in the closed position, the lower jaw 48 may be moved upwardly towards the upper jaw 24 to close the aperture 56, e.g., to secure a rail between the opposing jaws 24, 48. In the open position, the lever 18 may release the hook 14 such that the lower jaw 48 is free to move relative to the upper jaw 24.

Generally, the lever 18 is an elongate body including first and second ends 80, 82. The lever 18 includes a pair of apertures 78 in side surfaces 79 that define axis 42 (which is coextensive with axis 42 defined by apertures 40 in the end shell 12 once assembled, as shown in FIGS. 4A and 4B). Preferably, the apertures 78 are disposed closer to the second end 82 such that the first end 80 provides a relatively long lever arm that may be manipulated to move the lever 18 between the open and closed positions.

The lever 18 may also include one or more elements for securing the lever 18 in the closed position. For example, the first end 80 may include a pair of pockets 85 in the side surfaces 79 for receiving mating detents 98 on the end shell cover 96, as explained further below. Optionally, the lever 18 may also include a lock assembly 89 for locking the lever 18 in the closed position, as shown in FIGS. 1 and 3A.

The lever 18 may include one or more features for coupling the lever 18 to the crossbar plate 16 and/or the hook 14. For example, a lock assembly housing 81 may extend from the first end 80 of the lever that may contact the hook 14, thereby coupling movement of the hook 14 to movement of the lever 18, as explained further below.

In addition, as shown in FIGS. 7A and 7B, a flange 83 may extend from the second end 82 of the lever 18, thereby defining a slot 84 between the flange 83 and a curved surface 82a. During use of the apparatus 10, the flange 83, curved surface 82a, and/or slot 84 may allow the lever 18 to be coupled to the crossbar plate 16 via the locking shaft 76, also as explained below.

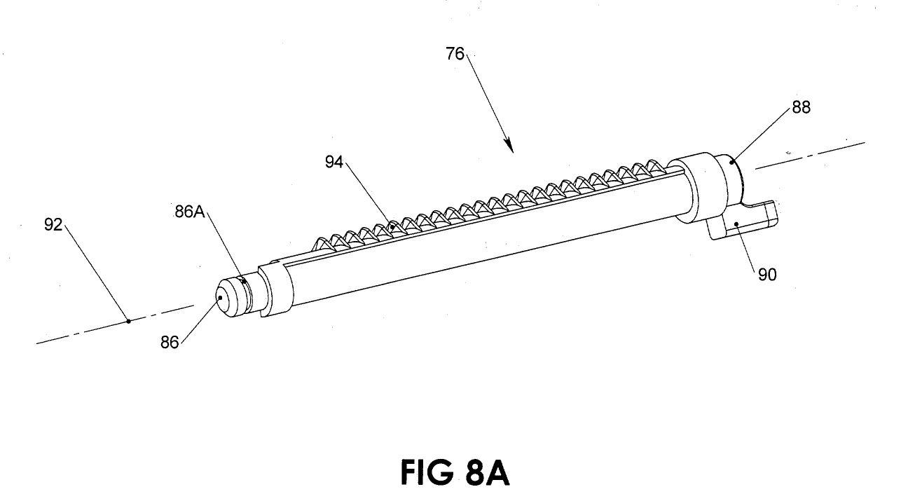

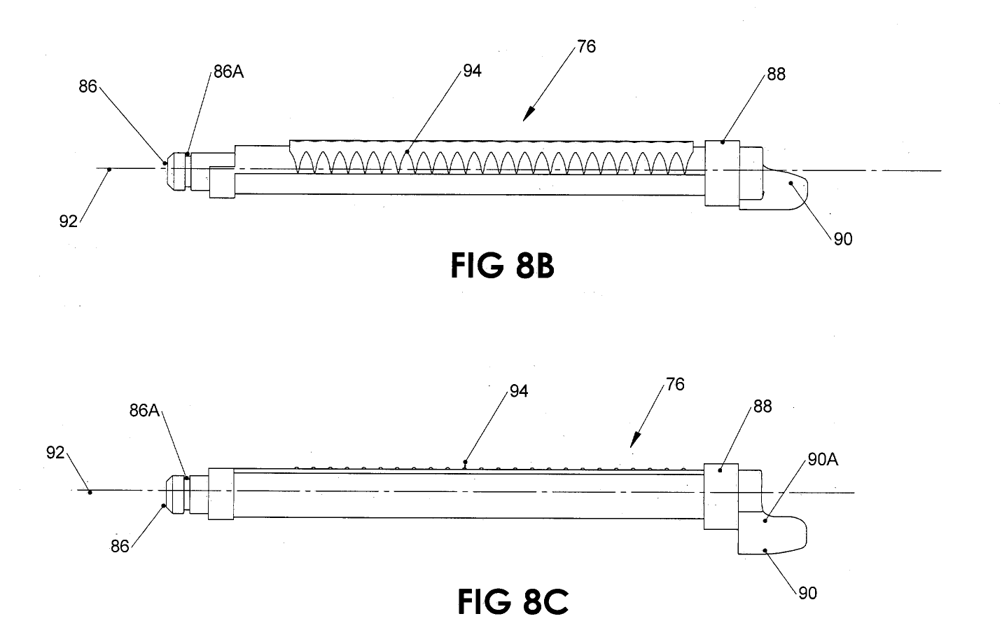

Turning to FIGS. 8A-8C, an exemplary embodiment of the locking shaft 76 is shown. Generally, the locking shaft 76 is a substantially rigid elongate member including first and second ends 86, 88. The first end 86 has a shape, e.g., a tapered shape, such that the first end 86 may be at least partially received in the socket 46 in the end wall 37 of the track 30 (not shown, see FIG. 4C). The first end 86 may also include a circumferential slot 86a for receiving a locking clip 87 (not shown, see FIG. 1). For example, after the first end 86 is inserted through the socket 46 in the end wall 37, the locking clip 87 may be snapped into the slot 86a, thereby preventing the first end 86 of the locking shaft 76 from being removed from the socket 46.

The second end 88 of the locking shaft 76 may include an eccentric tab 90 that extends from the second end 88. Preferably, the eccentric tab 90 is offset from a central axis 92 of the locking shaft 76 but extends substantially parallel to the central axis 92. More preferably, the eccentric tab 90 includes a radiused inner edge 90a that may facilitate coupling of the locking shaft 76 to the lever 18, as explained further below.

The locking shaft 76 also includes a plurality of teeth or other locking elements 94 that extend at least partially around the circumference of the locking shaft 76. The spacing and height of the teeth 94 correspond substantially to the teeth 74 on the crossbar plate 16 (not shown, see FIG. 6B), thereby providing cooperating locking elements, as explained further below.

Returning to FIG. 1, the apparatus 10 may be assembled as follows. Although particular components are described as being coupled to one another in a particular sequence below, this sequence is merely exemplary. It will be appreciated that a variety of sequences may be used to assemble the apparatus 10.

First, the hook 14 may be coupled to the end shell 12. With the end shell 12 supported upright, as shown in FIGS. 1 and 4A, the hubs 50 on the hook 14 may be inserted upwardly into the opening 25 from below the end shell 12 and then aligned with the sockets 38 in the end shell 12. The hook 14 may then be dropped until the hubs 50 are fully seated in the sockets 38. Preferably, the hubs 50 and sockets 38 have complementary shapes such that the hook 14 may freely pivot relative to the end shell 12 about the axis 39 while the hook 14 remains seated in the end shell 12.

With reference to FIGS. 3A, 4B, and 8A-8C, the locking shaft 76 may be coupled to the end shell 12. The locking shaft 76 may be disposed through the hole 31 in the intermediate wall 29 of the end shell 12 such that the second end 88 of the locking shaft 76 extends into the opening 25, as shown in FIG. 3A. The first end 86 of the locking shaft 76 may be received in the socket 46, and the locking clip 87 may be snapped into the slot 86a to prevent the first end 86 from being removed from the socket 46, as shown in FIGS. 1 and 3A. Thus, the locking shaft 76 may be coupled to the end shell 12, thereby preventing substantial axial movement of the locking shaft 76 while allowing it to rotate about the axis 92.

The crossbar plate 16 may then be inserted into the track 30 of the end shell 12 and coupled to the springs 68. With the upper surface 60 of the crossbar plate 16 in close proximity to the track 30, ends of the springs 68 may be secured to the hubs 66, 35 on the crossbar plate 16 and the end shell 12. The ledges 64 on the tab 62 on the crossbar plate 16 may be aligned with the enlarged region 36a of the slot 36, and the tab 62 seated in the slot 36, as explained above. Alternatively, one end of the springs 68 may be attached first to the hubs 66 on the crossbar plate 16, and received in the channels 32 as the crossbar plate 16 is coupled to the track 30. Thereafter, the other end of the springs 68 may be attached to the hubs 35 on the track 30.

Simultaneously with seating the crossbar plate 16 in the track 30, the portion of the locking shaft 76 extending along the track 30 may be received in the channel 72 of the crossbar plate 16. Thus, the upper surface 60 of the crossbar plate 16 may be in contact with or a short distance above the bottom surface 34 of the track 30. With the locking shaft 76 rotated such that the teeth 74, 94 on the crossbar plate 16 and locking shaft 76 disengaged, the crossbar plate 16 may be slid along the track 30 (e.g., by overcoming the resistance provided by the springs 68).

Next, the locking lever 18 may be coupled to the end shell 12, e.g., using a pin 44. With the end shell 12 upright, as shown in FIG. 4A, the first end 80 of the lever 18 may be aligned above the first end 22 of the end shell 12, and the lever 18 may be inserted partially into the opening 25 until the apertures 40, 78 in the end shell 12 and the lever 18 are adjacent one another. The pin 44 may then be inserted through the apertures 40, 78, thereby securing the lever 18 to the end shell 12, while allowing the lever 18 to pivot. It will be appreciated that other mechanisms may be used to pivotally couple the lever 18 to the end shell 12, such as mating hubs and pockets (not shown), and the like.

To couple the locking shaft 76 to the lever 18, and consequently to the crossbar plate 16, the lever 18 may be maintained at least partially in the open position (shown in FIG. 3B) as the lever 18 is being connected to the end shell 12. As the second end 82 of the lever 18 is inserted into the opening 25 in the end shell 12, the tab 90 on the locking shaft 76 may be at least partially received in the slot 84 on the second end 82 of the lever 18. This may require rotating the locking shaft 76 to an orientation in which the tab 90 is aligned with the slot 84.

Once the lever 18 is coupled to the end shell 12, the lever 18 may be moved towards the closed position, as shown in FIG. 3A. As the lever 18 is moved towards the closed position, the tab 90 on the locking shaft 76 may slidably engage the slot 84 behind the flange 83. Specifically, as the first end 80 of the lever 18 is lowered to move the lever 18 towards the closed position, the flange 83 on the second end 82 of the lever 18 may rise, thereby pushing the tab 90 upwardly and rotating the locking shaft 76. Once the lever 18 is in the closed position, as shown in FIG. 3A, the teeth 94 on the locking shaft 76 may be rotated into engagement with the teeth 74 on the crossbar plate 16, as shown in FIGS. 3D and 3E. With the teeth 74, 94 interlocked, the crossbar plate 16 cannot be moved relative to the locking shaft 76, and consequently, the crossbar plate 16 may be secured at the current location along the track 30.

When the lever 18 is moved from the closed position towards the open position, the curved surface 82a on the second end 82 of the lever 18 and/or the flange 83 may push the tab 90 downwardly, thereby rotating the locking shaft 76 to disengage the teeth 74, 94. With the teeth 74, 94 disengaged, the crossbar plate 16 may be directed along the track 30, as desired (e.g., by overcoming the bias of the springs 68). While the lever 18 is in the open position, the curved surface 82a on the second end 82 of the lever 18 may prevent the tab 90 on the locking shaft 76 from rising, thereby preventing the locking shaft 76 from rotating back to a position where the teeth 74, 94 may interlock.

In addition, the lever 18 may cooperate with the hook 14 to open and/or close the opposing jaws 24, 48, as shown in FIGS. 3A and 3B. For example, the lever 18 may include a ridge 83a that may engage the hook 14 to move the lower jaw 48. Preferably, as best seen in FIG. 3A, as the lever 18 is moved to the closed position, the ridge 83a engages the ledge 59 on the hook 14, pushing the ledge 59 downwardly. This pivots the hook 14 about the hubs 50, thereby moving the lower jaw 48 upwardly towards the upper jaw 24 and reducing the size of the aperture 56. Thus, a rail or other structure (not shown) may be securely engaged between the opposing jaws 24, 48 when the lever is moved to the closed position.

Once the lever 18 is moved to the closed position, it may be desired to lock the lever 18, thereby preventing someone from opening the lever 18 and tampering or removing the apparatus 10 (or a crossbar 120 to which the apparatus 10 is attached). For example, as shown in FIG. 3A, the lock assembly 89 may include one or more catches 89a. When the lock assembly 89 is unlocked, the catch(es) 89a may extend generally parallel to the longitudinal axis 28 (not shown, see FIG. 3B). With the catch(es) 89a in this orientation, the lever 18 may be closed, causing the catch(es) 89a to enter the slot 58 (not shown, see FIG. 5) in the hook 14. Once the lever 18 is closed, the lock assembly 89 may be locked, causing the catch(es) 89a to rotate and pass under the ledge 59, as shown in FIG. 3A. With the catch(es) 89a under the ledge 59, the lever 18 cannot be moved from the closed position, thereby substantially securing the opposing jaws 24, 48 around the rail.

Alternatively or in addition, as shown in FIG. 1, the lever 18 may be secured in the closed position by cooperating detents on the lever 18 and/or the end shell cover 96. As explained above, the end shell cover 96 may be received over the end shell 12 to provide a contoured profile and/or a desired aesthetic appearance. The end shell cover 96 may be substantially permanently or removably attached to the end shell 12, e.g., using an adhesive and/or mechanical connectors.

In addition, the end shell cover 96 may include a recess 97 for receiving the lever 18 as the lever 18 is moved towards the closed position, thereby reducing the profile of the lever 18. Detents 98 may be provided in the recess 97 that may be received in pockets 85 (not shown, see FIG. 7A) in the lever 18 as the lever 18 is closed. Preferably, the detents 98 include ramped upper edges, thereby accommodating the lever 18 being received in the recess 97. In addition, the detents 98 include blunt lower edges such that, once the detents 98 are received in the pockets 85, the detents 98 cannot be removed, thereby preventing the lever 18 from being moved from the closed position.

To disengage the detents 98 from the pockets 85, a key 99 (see FIG. 1) may be slid under the first end 80 of the lever 18 into the recess 97. The detents 98 may have ramped leading edges that may be engaged by the key 99 such that, as the key 99 is advanced under the lever 18, the key 99 may push the detents 98 out of the pockets 85, thereby allowing the lever 18 to be opened again.

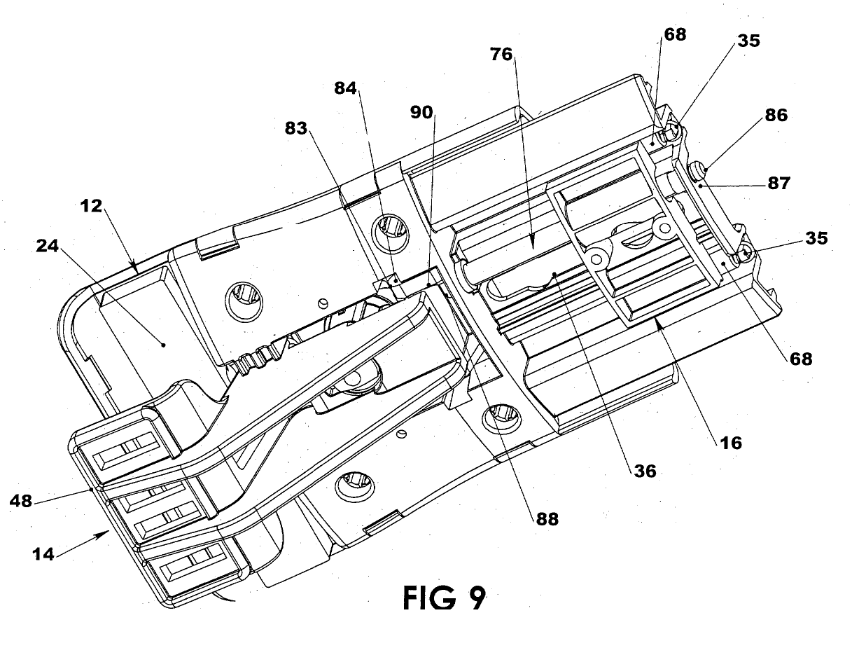

To accommodate the heel 52 of the hook 14, the underside of the lever 18 may be hollow, i.e., including a cavity 91, as shown in FIG. 7C, that extends at least partially between the first and second ends 80, 82 of the lever. The flange 83 and curved edge 82a on the lever 18 may be offset laterally from the central longitudinal axis 28 of the end shell 12 so as not to encroach on the cavity 91. As the lever 12 is moved towards the open position, as shown in FIGS. 3B and 9, the heel 52 of the hook 14 may freely enter the cavity 91, thereby avoiding contact between the heel 52 and the second end 82 of the lever 18 when the lower jaw 48 is moved away from the upper jaw 24. Thus, as the lever 18 is opened, the ridge 83a on the lever 18 may be disengaged from the ledge 59 on the hook 14, thereby allowing the hook 14 to be pivoted to move the lower jaw 48 away from the upper jaw 24.

Returning to FIG. 1, an apparatus 10 in accordance with the present invention may be attached to a crossbar 120, thereby providing a grabber for securing the crossbar 120 to a rail or other structural component of a rack system (not shown). The crossbar 120 may be a substantially rigid elongate member having a first end 122 and a second end (not shown). Similar to the apparatus 10, the crossbar 120 may be formed as one or more parts and may be formed from a variety of materials, such as metal, ceramic, plastic, and/or composite materials, which may be extruded, machined, roll formed or otherwise formed. Preferably, the crossbar 120 is a hollow structure having an elliptical cross-section, e.g., to provide a desired aerodynamic performance and/or aesthetic appearance.

In a preferred embodiment, the crossbar 120 includes a groove or track 124 that extends at least partially between the first end 122 and the second end. The track 124 may have any of a variety of configurations for accommodating receiving accessories, e.g., carriers and/or mounts, that may be secured to a rack system for carrying articles, as is known in the art.

During assembly, the second end 26 of the end shell 12, including the track 30 (not shown, see FIGS. 4A and 4B), may be at least partially inserted into the first end 122 of the crossbar 120. The first end 122 of the crossbar 120 may then be substantially secured to the crossbar plate 16. For example, as shown in FIG. 1, one or more holes 125 may be provided in the first end 122 of the crossbar 120, preferably in the track 124. One or more holes 63 in the tab 62 of the crossbar plate 16 (not shown, see FIGS. 6A and 6B) may be aligned with respective holes 125 in the crossbar 120. One or more screws 126 or other fasteners (not shown, see FIG. 1) may be threaded or otherwise inserted into the holes 63, 125 to substantially secure the crossbar plate 16 to the crossbar 120. Alternatively, the crossbar plate 16 may be substantially permanently or removably attached to the crossbar 120, e.g., using an adhesive or other bonding material, by welding, and the like.

To provide a flush finish and/or to reduce noise or drag, trim 128 may be inserted into the track 124, as is well known to those skilled in the art. Optionally, another grabber apparatus (not shown) may be provided on the second end (also not shown) of the crossbar 120. The grabber apparatus on the second end may be an adjustable apparatus, similar to the embodiment described above. Alternatively, a fixed length grabber apparatus may be provided, e.g., including opposing jaws, which may be adjusted to secure the second end of the crossbar 120 to a rail or other structure (not shown).

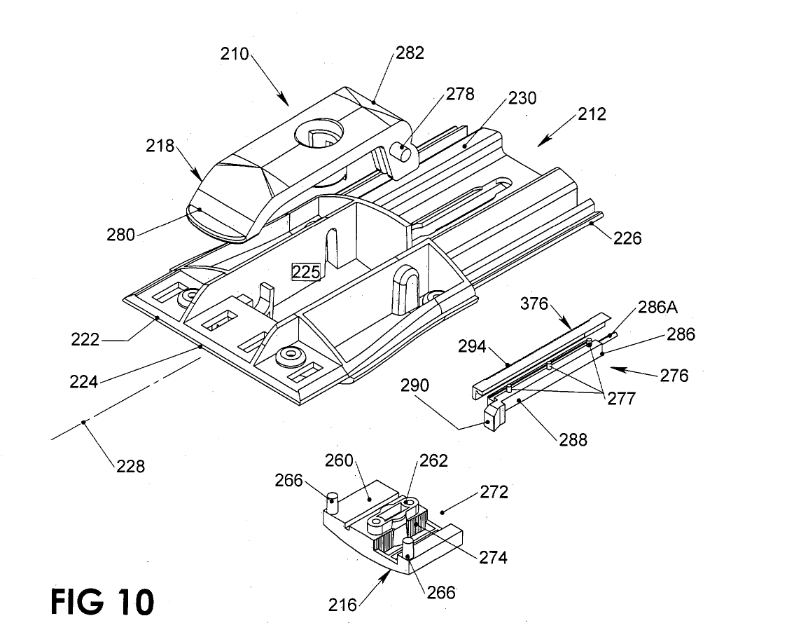

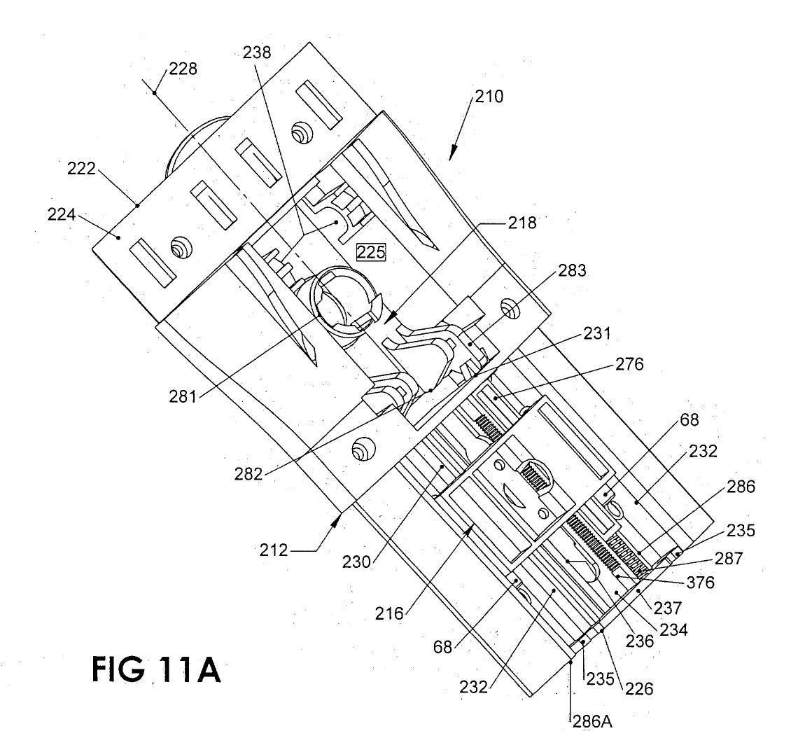

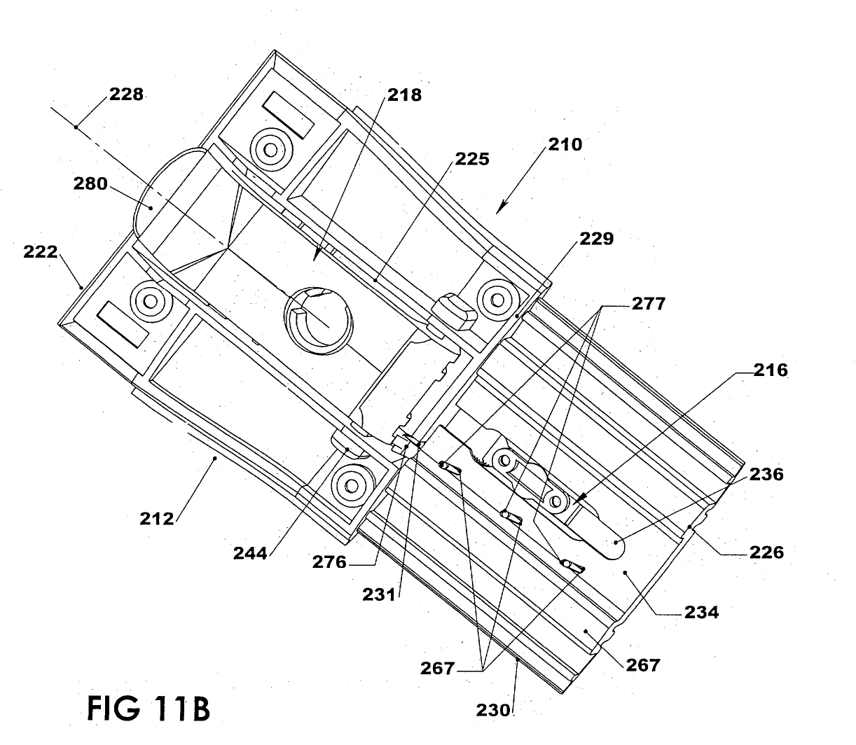

Turning to FIGS. 10-11B, an alternative embodiment of an apparatus 210 for securing a crossbar (not shown) to a rail (also not shown) may include an end shell 212, a hook (not shown) coupled to the end shell 212, a crossbar plate 216 slidable relative to the end shell 12, and a lever 218 for releasing and/or securing the hook and/or the crossbar plate 216 relative to the end shell 212, generally similar to the embodiment described above. The apparatus 210 may also include an end shell cover (not shown) attachable to the end shell 212, also similar to the previous embodiment.

Unlike the apparatus 10 described above, the apparatus 210 includes a cooperating rod 276 and backing plate 376 for coupling the lever 218 to the crossbar plate 216, e.g., to release and/or secure the crossbar plate 216 relative to the end shell 212.

Similar to the previous embodiment, the end shell 212 includes a first end 222 and a second end 226, thereby defining a longitudinal axis 228 therebetween. The first end 222 includes an upper or first jaw 224, and the second end 226 includes a track 230 for slidably receiving the crossbar plate 216 there along. The second end 226 of the end shell 212 may be shaped such that the second end 226 may be inserted into a similarly shaped end of a crossbar (not shown), similar to the embodiment described above. An opening 225 may extend through the end shell 212 transverse to the longitudinal axis 228 for receiving the hook (not shown), also similar to the previous embodiment.

As best seen in FIG. 11A, the track 230 may include a pair of channels 232 on either side of a bottom wall 234. The bottom wall 234 may include an elongate slot 236 therethrough that extends substantially parallel to the longitudinal axis 228, similar to the previous embodiment. In addition, as shown in FIG. 11B, one or more slots 267 may be provided in the bottom surface 234 of the track 230. Preferably, the slots 267 extend diagonally relative to the longitudinal axis 228.

In addition, the end shell 212 may include mounts for securing various components of the apparatus 210 to the end shell 212, such as “C” shaped sockets 238 for receiving hubs on the hook (not shown), apertures (not shown) for receiving a pin 244 to pivotally couple the lever 218 to the end shell 212, and/or one or more hubs (also not shown) for securing an end of a spring 287 (not shown, see FIG. 11A) relative to the track 230.

As best seen in FIG. 10, the crossbar plate 216 may include a substantially flat upper surface 260 including an elongate tab 262 and/or one or more hubs 266 to provide mounts for springs 68 (not shown, see FIG. 11A). Similar to the previous embodiment, the tab 262 may be received in the slot 236 and the hubs 266 and springs 68 may be received in the channels 232 of the track 230. Thus, as the crossbar plate 216 is slid along the track 230, the hubs 266 may slide within the channels 232, compressing or extending the springs 68.

The crossbar plate 216 may also include a channel 272 for receiving the locking rod 276 and backing plate 376 therein. The channel 272 may include one or more locking elements that interlock with mating locking elements on the backing plate 376 and/or locking rod 276. For example, the channel 272 may include a plurality of serrations or teeth 274 extending along one wall of the channel 272.

The lever 218 may be pivotally coupled to the end shell 212 and movable between closed and open positions, similar to the previous embodiment. Generally, the lever 218 includes first and second ends 280, 282, and may include one or more elements for securing the lever 218 in the closed position, such as a lock assembly and/or cooperating detents (not shown), similar to the previous embodiment.

The second end 282 may include one or more features for coupling the lever 218 to the crossbar plate 216 and/or the hook (not shown). For example, a flange 283 may extend from the second end 282 of the lever 218 to couple movement of the crossbar plate 216 to movement of the lever 218, as explained further below. In addition, a lock assembly housing 281 may contact the hook (not shown), thereby coupling movement of the hook to movement of the lever 218, similar to the previous embodiment.

With particular reference to FIG. 10, the locking rod 276 is a substantially rigid elongate rod, shaft, or other member including first and second ends 286, 288. The first end 286 includes a narrow finger 286a, and the second end 288 includes an enlarged tab 290. In addition, the locking rod 276 includes one or more tabs 277 spaced apart along the length of the locking rod 276 and extending transversely therefrom. Preferably, the number and spacing of the tabs 227 corresponds to the slots 267 provided in the track 230.

The backing plate 376 includes a plurality of serrations or teeth 294 that extend along a side surface of the backing plate 376. The spacing and height of the serrations 294 correspond substantially to the serrations 274 on the crossbar plate 216, thereby providing cooperating locking elements.

The apparatus 210 is generally assembled similar to the previous embodiment. For example, the lever 218 and hook (not shown) may be pivotally coupled to the end shell 212, e.g., using pins (not shown) or cooperating hubs 278 and sockets. The second end 288 of the locking rod 276 may be disposed through a slot 231 (shown in FIG. 11B) in the intermediate wall 229 of the end shell 212 such that the locking rod 276 is disposed along the track 230, similar to the previous embodiment.

Unlike the previous embodiment, as shown in FIG. 11A, a spring 287 is disposed around the finger 286a on the first end 286 of the locking rod 276 that extends between the first end 286 of the locking rod 276 and the end wall 237 of the track 230. Preferably, the spring 287 is an extension spring that is loaded at least partially compressed between the end wall 237 and the first end 286 of the locking rod 276. Thus, the locking rod 276 may be biased to move away from the end wall 237 with the bias being limited by the length of the slots 267 within which the tabs 277 slide. Alternatively, other springs or biasing mechanisms may be provided, as will be appreciated by those skilled in the art.

In addition, as shown in FIG. 11B, as the locking rod 276 is disposed along the track 230, the tabs 277 on the locking rod 276 are received in the slots 267 in the bottom surface 234 of the track 230. The backing plate 376 may also be disposed along the track 230 between the locking rod 276 and the wall of the channel 272 including the serrations 274. The backing plate 376 may be inserted before, simultaneous with, or after the locking rod 276, and is preferably free-floating adjacent the locking rod 276. Alternatively, the backing plate 376 may be attached to the locking rod 276 (not shown), or the backing plate 376 may be eliminated and serrations or teeth (also not shown) may be provided on the locking rod 276 adjacent the wall of the channel 272 including the serrations 274.

The tabs 277 and slots 267 on the locking rod 276 and track 230 may limit and/or guide movement of the locking rod 276 within the track 230. Preferably, as the tabs 277 slide in the slot 267, the locking rod 276 directs the backing plate 376 towards or away from the serrations 274 in the channel 272, as explained further below.

The crossbar plate 216 may then be received in the track 230 such that a portion of the locking rod 276 and backing plate 376 are received in the channel 272. Because of the spring 287 and the diagonal orientation of the slots 267, the locking rod 276 may be biased to move away from the wall of the channel 272 including the serrations 274. Thus, the crossbar plate 216 may be free to move along the track 230, and consequently, a crossbar (not shown) coupled to the crossbar plate 216 may be moved relative to the end shell 212, similar to the previous embodiment.

The lever 218 may be used to secure the crossbar plate 216 (and consequently a crossbar attached thereto) at a location along the track 230. As explained above, the second end 282 of the lever 218 may include a flange 283. As the lever 218 is moved towards the closed position, the flange 283 may contact the enlarged tab 290 on the second end 288 of the locking rod 276. This action may overcome the bias of the spring 287 and push the locking rod 276 axially along the track 230 towards the end wall 237.

Because of the diagonal orientation of the slots 267, the tabs 277 cause the locking rod 276 to move diagonally across the track 230, thereby pushing the backing plate 376 until the serrations 294 on the backing plate 376 engage the mating serrations 274 in the channel 272 of the crossbar plate 216. Thus, as long as the lever 218 remains in the closed position, the flange 283 may retain the serrations 274, 294 interlocked, thereby preventing the crossbar plate 216 from being moved along the track 230. To move the crossbar plate 216, the lever 218 may be moved to the open position, thereby disengaging the flange 283 from the enlarged tab 290. This allows the spring 287 to push the locking rod 276 away from the end wall 237 and disengage the serrations 294, 274 on the backing plate 376 and crossbar plate 216.

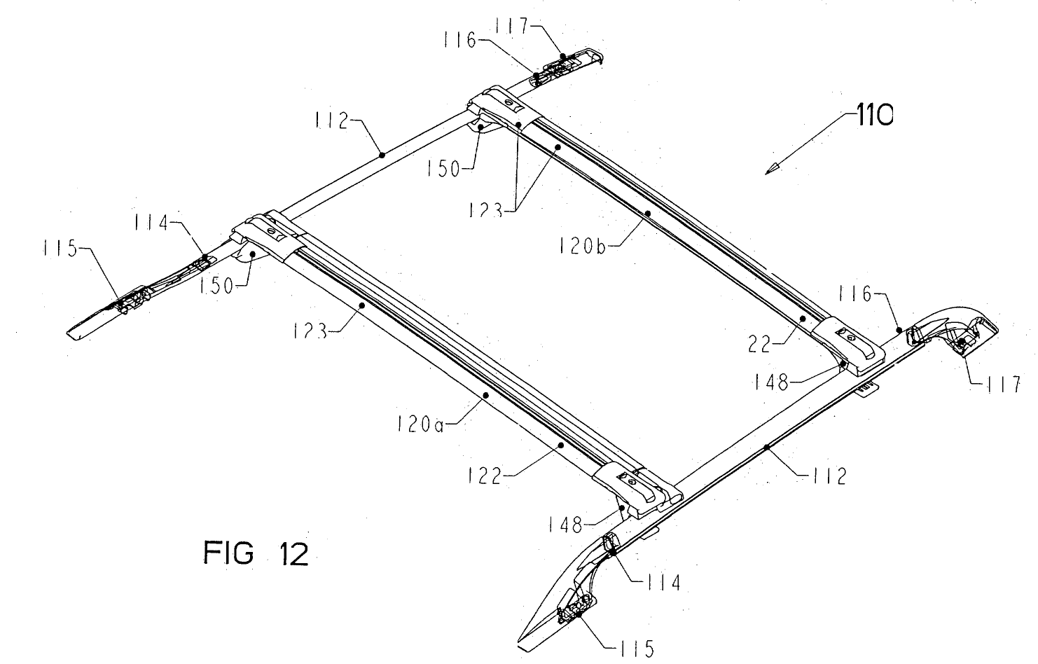

One or more crossbars, each with an adjustable grabber apparatus on one or both ends may be incorporated into a roof rack or other carrier system. The system may be mounted on an exterior surface of a vehicle, such as to a roof, deck lid, or trunk of a car, truck, van, or other automobile. For example, an exemplary roof rack system 110 is shown in FIG. 12 that includes a pair of rail members 112 and a pair of crossbars 120a, 120b extending between the rail members 112. The rail members 112 may be substantially rigid elongate members including first and second ends 114, 116, which may be constructed of similar materials and using similar methods to those described above. The rail members 112 may be substantially uniform in cross-section along their lengths, or may include a plurality of undulations, such as those disclosed in co-pending application Ser. No. 09/713,760, filed Nov. 14, 2000, the disclosure of which is expressly incorporated herein by reference. Alternatively, other spaced-apart connectors or elements may be provided on the rail members 112, as is well known to those skilled in the art.

The rail members 112 may be attached directly to a roof, trunk, deck lid, or other outer surface of a vehicle, such as a car, van, or truck (not shown). For example, the rail members 112 may include a plurality of apertures (not shown) at spaced apart intervals for receiving fasteners therethrough, such as a screw, rivet, bolt, and the like (not shown), to secure the rail members 112 directly to an outer surface. Alternatively or in addition, the rail members 112 may be bonded to the outer surface, using an adhesive or other bonding material.

In a further alternative, the rail members 112 may include feet 115, 117 attached at or near the ends 114, 116. The feet may be attached to an outer surface of a vehicle (not shown) in a conventional manner, such as using fasteners or adhesives, as described above.

The crossbars 120 may span across between the rail members 112, thereby facilitating carrying cargo using the rail system 110 and/or receiving accessories, such as bicycle or ski racks, baskets, and the like. Each crossbar 120 has an “overall length” defined herein as the distance between the opposing jaws 148 on one end 122 of the crossbar 120 and the opposing jaws 150 on the other end 123 of the crossbar 120.

At least one of the sets of opposing jaws 148 is included on an adjustable grabber apparatus, such as the apparatus 10 shown in FIGS. 1-9 and described above. The apparatus 10 may include an end shell 12 carrying the opposing jaws 148, a crossbar plate (not shown) that is slidable along a track (not shown) of the end shell 12, and a locking lever 18. Because the crossbar plate is secured to the crossbar 120, when the crossbar plate is moved along the track, the distance between the opposing jaws 148 and the end 122 of the crossbar 120 may be adjusted, thereby adjusting the overall length of the crossbar 120. The other set of opposing jaws 150 may also be adjustable or may be fixed relative to the respective end of the crossbar 120 and/or each other.

As shown in FIG. 12, the rail members 112 may not extend in a direction substantially parallel to one another. Thus, the first ends 114 of the rail members 112 may be further apart than the second ends 116. The difference in the distance of the span between the rail members 112 at each of their ends 114, 116 may vary by about zero to four inches (zero to ten centimeters). Because of this configuration, the overall length of the crossbar 120a must necessarily be greater than the overall length of the crossbar 120b near the second ends 116 in order for the crossbars 120 to span between and be secured to the rail members 112.

To mount the first crossbar 120a between the rail members 112, the lever 18 on the apparatus 10 (not shown, see FIGS. 1-9) may be opened, thereby allowing the crossbar plate (not shown) to slide relative to the end shell 12, and consequently, allowing the overall length of the crossbar 120a to be adjusted. The opposing jaws 148 on the adjustable grabber apparatus 10 may be moved inwardly towards the crossbar 120 to minimize the overall length and accommodate disposing the crossbar 120 between the rail members 112.

If the crossbar plate is biased to move away from the opposing jaws 148 (i.e., to maximize the overall length of the crossbar 120a), the opposing jaws 148 may automatically move outwardly away from the end 122 of the crossbar 120 until they receive the rail 112 therebetween. The lever 18 may then be closed, thereby substantially securing the crossbar plate, and consequently fixing the distance between the crossbar 120a and the opposing jaws 148. Simultaneously, the opposing jaws 148 may be closed around the rail member 112, thereby substantially securing the crossbar 120a along the length of the rail member 112. Thus, the lever 18 may substantially simultaneously lock the length adjustment of the crossbar 120 at the same time that the rail member 112 is secured between the opposing jaws 148.

If it is desired to move the crossbar 120a to a new location along the length of the rail member 112, the lever 18 may be opened, thereby releasing the rail member 112 from between the opposing jaws 148 and releasing the crossbar plate. The crossbar 120a may be moved along the length of the rail 112, the crossbar plate sliding freely along the track to adjust the overall length of the crossbar 120. If the spacing between the rail members 112 increases as the crossbar 120 is moved, the opposing jaws 148 may automatically move outwardly because of the bias of the crossbar plate, thereby maintaining the opposing jaws 148 in contact with the rail member 112. If the spacing between the rail members 112 decreases, the opposing jaws 148 may slide inwardly towards the crossbar 120a against the bias of the crossbar plate. Once the new location is attained, the lever 18 may be closed, thereby fixing the overall length of the crossbar 120a and securing the rail member 112 between the opposing jaws 148.

The opposing jaws 150 on the second end 123 of the crossbar 120a may be secured around the rail member 112 in a similar manner (if adjustable) or by otherwise tightening the opposing jaws 150 around the rail member 112. The other crossbar 120b may be mounted and/or adjusted in a similar manner.

Because the overall lengths of the crossbars 120 may be adjusted using the apparatus 10, the crossbars 120 themselves may have the same length. This may eliminate or reduce the need for custom length crossbars, and allow standard lengths to be provided. In addition, if apparatus 10 are provided on both ends of the crossbars, the crossbars may be self-centering, since the bias of the respective crossbar plates may push the crossbar to a central location between the apparatus 10 on each end.

It will be appreciated that an apparatus in accordance with the present invention may be used to allow adjustment of a variety of crossbars or other members that may be secured indirectly or directly to structures, such as a vehicle surface. For example, the apparatus may be incorporated into a surface mount carrier system to secure the system directly to a surface, e.g., a roof, of a vehicle. Unlike the embodiments described above, a surface mount carrier system may include a hook coupled to the end shell that includes a single jaw. Preferably, rather than orienting the jaw towards the housing, the jaw may be oriented away from the housing, e.g., transversely, i.e., diagonally or substantially perpendicular, to a longitudinal axis of the crossbar. Preferably, with such adjustable transverse jaws on each end of a crossbar, the crossbar may be secured on opposite edges of a surface, such as the rain gutters on opposite sides of a vehicle roof. The end shells may allow adjustment of the overall length of the crossbar, while the jaws may be used to grasp respective edges of the vehicle surface to substantially secure the system to the vehicle surface.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. An apparatus for securing a crossbar to a rail of a rack system for a vehicle, comprising:
a housing comprising a first end including a first jaw and a second end including a track;
a crossbar plate slidable along the track such that a distance between the crossbar plate and the first jaw varies as the crossbar plate slides along the track;
a hook coupled to the housing, the hook comprising a second jaw disposed opposite the first jaw such that an aperture is defined between the first and second jaws for receiving a portion of a rail therebetween, the hook being movable relative to the housing, thereby moving the second jaw relative to the first jaw to adjust a size of the aperture; and
a lever coupled to the housing and movable between open and closed positions, the lever securing the crossbar plate at a location along the track in the closed position and releasing the crossbar plate to move freely along the track in the open position.

2. The apparatus of claim 1, wherein the lever is coupled to the hook such that, in the closed position, the second jaw moves towards the first jaw to minimize the size of the aperture, and, in the open position, the lever releases the hook such that the second jaw is free to move relative to the first jaw.

3. The apparatus of claim 2, wherein the hook is pivotally coupled to the housing, the hook comprising an extension opposite the second jaw, the lever pushing against the extension in the closed position to move the second jaw towards the first jaw.

4. The apparatus of claim 2, further comprising an elongate rail receivable in the aperture, the first and second jaws engaging the rail to substantially fix the housing at a location along a length of the rail when the lever is in the closed position, the first and second jaws releasing the rail to allow the housing to be freely moved along the rail when the lever is in the open position.

5. The apparatus of claim 1, further comprising a locking element carried by the housing, the locking element comprising a first end coupled to the lever and a region engaging the crossbar plate when the lever is in the closed position to secure the crossbar plate at a location along the track.

6. The apparatus of claim 5, wherein the region of the locking element engaging the crossbar plate and the crossbar plate comprise one or more cooperating teeth that engage one another when the lever is in the closed position to prevent movement of the crossbar plate relative to the locking element.

7. The apparatus of claim 6, wherein the locking element comprises an elongate shaft attached to the housing, the shaft rotatable about its longitudinal axis as the lever is moved between the open and closed positions to disengage and engage, respectively, the one or more cooperating teeth.

8. The apparatus of claim 7, wherein the lever comprises a slot and the shaft comprises a tab on the first end receivable in the slot such that movement of the lever causes the tab to move along the slot to rotate the shaft about the longitudinal axis, the one or more cooperating teeth disengaging or engaging as the shaft rotates.

9. The apparatus of claim 1, wherein the locking element comprises an elongate rod at least partially received in a channel in the crossbar plate, the channel comprising the one or more teeth on the crossbar plate, the lever moving the rod transversely relative to the track when the lever is moved to the closed position, thereby engaging the one or more teeth on the shaft and the one or more teeth in the channel.

10. The apparatus of claim 1, wherein the track extends substantially parallel to an axis extending between the first and second ends of the housing.

11. The apparatus of claim 1, wherein the crossbar plate is biased towards one end of the track.

12. The apparatus of claim 11, wherein the crossbar plate is biased to an end of the track closest to the first jaw.

13. The apparatus of claim 11, further comprising a spring coupled to the housing and the crossbar plate for biasing the crossbar plate towards one end of the track.

14. The apparatus of claim 1, further comprising a crossbar including a first end attached to the crossbar plate such that a distance between the first end of the crossbar and the first jaw varies as the crossbar plate slides along the track.

15. The apparatus of claim 14, wherein the second end of the housing is at least partially inserted into the first end of the crossbar, the second end of the housing being slidable at least partially in and out of the first end of the crossbar as the crossbar plate slides along the track.

16. The apparatus of claim 14, wherein the crossbar comprises a second end including a grabber for securing the second end of the crossbar to a rail.

17. The apparatus of claim 1, further comprising a lock carried by the lever, the lock comprising a tab that engages the hook when the lever is in the closed position and the lock is engaged to prevent the lever from being moved from the closed position.

18. The apparatus of claim 1, wherein the housing comprises a pocket within which the lever is received in the closed position.

19. The apparatus of claim 18, wherein the pocket of the housing and the lever comprise cooperating detents that substantially lock the lever in the closed position.

20. The apparatus of claim 19, further comprising a key insertable into the pocket between the lever and the housing for disengaging the cooperating detents such that the lever may be released from the closed position.

21. A rack system for a vehicle, comprising:
first and second rails securable to a surface of a vehicle;
a crossbar including first and second ends and having a length less than a distance between the first and second rails;
a first end shell secured to the first end of the crossbar, the first end shell comprising a pair of opposing jaws for receiving the first rail therebetween, and a first lever movable between open and closed positions, the first end shell being movable relative to the crossbar when the first lever is in the open position and fixed relative to the crossbar when the first lever is in the closed position; and
a second end shell secured to the second end of the crossbar, the second end shell being securable to the second rail.

22. The rack system of claim 21, wherein at least one of the opposing jaws is coupled to the first lever for securing the first rail between the opposing jaws when the first lever is in the closed position.

23. The rack system of claim 21, wherein the first end shell comprises:
a housing comprising a first end including a first jaw and a second end slidably coupled to the crossbar, the first lever being pivotally coupled to the housing; and
a hook coupled to the housing, the hook comprising a second jaw disposed opposite the first jaw such that an aperture is defined between the first and second jaws for receiving the first rail therebetween, the hook being movable relative to the housing, thereby moving the second jaw relative to the first jaw to adjust a size of the aperture.

24. The rack system of claim 23, wherein the second end of the housing comprises a track, and wherein a crossbar plate is slidable along the track such that a distance between the crossbar plate and the first jaw varies as the crossbar plate slides along the track, the crossbar being attached to the crossbar plate.

25. The apparatus of claim 24, wherein the first end shell further comprises a locking element carried by the housing, the locking element comprising a first end coupled to the first lever and a second end engaging the crossbar plate when the first lever is in the closed position to secure the crossbar plate at a location along the track.

26. The apparatus of claim 25, wherein the second end of the locking element and the crossbar plate comprise one or more cooperating teeth and pockets that engage one another when the first lever is in the closed position to prevent movement of the crossbar plate relative to the locking element.

27. The apparatus of claim 6, wherein the locking element comprises an elongate shaft attached to the housing, the shaft rotatable about its longitudinal axis as the first lever is moved between the open and closed positions to disengage and engage, respectively, the one or more cooperating teeth and pockets.

28. The apparatus of claim 27, wherein the first lever comprises a slot and the shaft comprises a tab on the first end receivable in the slot such that movement of the first lever causes the tab to move along the slot to rotate the shaft about the longitudinal axis, the one or more cooperating teeth and pockets disengaging or engaging as the shaft rotates.

29. The rack system of claim 21, wherein, the second end shell comprising a pair of opposing jaws for receiving the second rail therebetween, and a second lever movable between open and closed positions, the second end shell being movable relative to the crossbar when the second lever is in the open position and fixed relative to the crossbar when the second lever is in the closed position.

30. The rack system of claim 29, wherein at least one of the opposing jaws is coupled to the second lever for securing the second rail between the opposing jaws when the second lever is in the closed position.

31. A method for adjusting a rack system comprising first and second spaced-apart rails fixed to a surface of a vehicle, the method comprising:
providing a crossbar extending between the first and second rails, the crossbar comprising a first end including a first end shell comprising a pair of opposing jaws for receiving the first rail therebetween and a second end including a second end shell securable to the second rail;
opening a locking lever on the first end shell to release the opposing jaws from the first rail and allow movement of the first end shell relative to the crossbar;
moving the crossbar along a length of the first and second rails, the first end shell moving freely relative to the crossbar to accommodate any change in spacing between the first and second rails; and
closing the locking lever on the first end shell to secure the first end shell relative to the crossbar and to secure the first rail between the opposing jaws to fix the crossbar relative to the first rail.

32. The method of claim 31, wherein the second end shell comprises a pair of opposing jaws for receiving the second rail therebetween, the method further comprising:
opening a locking lever on the second end shell to release the opposing jaws from the second rail and allow movement of the second end shell relative to the crossbar; and
closing the locking lever on the second end shell to secure the second end shell relative to the crossbar and to secure the second rail between the opposing jaws to fix the crossbar relative to the second rail.

33. An apparatus for securing a crossbar to a rail of a rack system for a vehicle, comprising:
a housing comprising a first end and a second end defining a longitudinal axis therebetween, the second end including a track;
a crossbar plate slidable along the track such that a distance between the crossbar plate and the first jaw varies as the crossbar plate slides along the track;
a hook coupled to the first end of the housing and including a jaw, the hook being movable relative to the housing, thereby moving the jaw relative to the second end of the housing; and
a lever coupled to the housing and movable between open and closed positions, the lever securing the crossbar plate at a location along the track in the closed position and releasing the crossbar plate to move freely along the track in the open position.

34. The apparatus of claim 33, wherein the hook is pivotally coupled to the housing, and wherein the lever is coupled to the hook such that, as the lever is moved towards the closed position, the jaw of the hook is moved towards the second end of the housing, and, in the open position, the lever releases the hook such that the jaw is free to move.

35. The apparatus of claim 33, further comprising a crossbar including a first end attached to the crossbar plate such that a distance between the first end of the crossbar and the first end of the housing varies as the crossbar plate slides along the track.

36. The apparatus of claim 35, wherein the second end of the housing is at least partially inserted into the first end of the crossbar, the second end of the housing being slidable at least partially in and out of the first end of the crossbar as the crossbar plate slides along the track.
